(19) United States
(12) Patent Application Publication
(10) Pub. No.: US 2010/0006174 A1
(43) Pub. Date: Jan. 14, 2010

(54) ROTARY BEVERAGE BOTTLE FILLING MACHINE CONFIGURED TO FILL BEVERAGE BOTTLES WITH DIFFERENT DIAMETERS, SIZES, AND SHAPES WITHOUT CHANGING BOTTLE CARRIERS AND A CONTAINER TREATMENT MACHINE CONFIGURED TO HANDLE CONTAINERS WITH DIFFERENT DIAMETERS, SIZES, AND SHAPES WITHOUT CHANGING CONTAINER CARRIERS

(76) Inventor: Volker TILL, Hofheim am Taunus (DE)

Correspondence Address: NILS H. LJUNGMAN & ASSOCIATES, P. O. BOX 130, GREENSBURG, PA, 15601-0130, US

(21) Appl. No.: 12/353,999

(22) Filed: Jan. 15, 2009

Related U.S. Application Data
(63) Continuation-in-part of application No. PCT/EP2007/006306, filed on Jul. 17, 2007.

(30) Foreign Application Priority Data
Jul. 20, 2006 (DE) 10 2006 033 511.2

(51) Int. Cl. B67C 3/24; B65B 3/04

(52) U.S. Cl. 141/1; 141/152

(57) ABSTRACT

A rotary beverage bottle filling machine configured to fill beverage bottles with different diameters, sizes, and shapes without changing bottle carriers and a container treatment machine configured to handle containers with different diameters, sizes, and shapes without changing container carriers. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-ln-Part application of International Patent Application No. PCT/EP2007/006306, filed on Jul. 17, 2007, which claims priority from Federal Republic of Germany Patent Application No. 10 2006 033 511.2, filed on Jul. 20, 2006. International Patent Application No. PCT/EP2007/006306 was pending as of the filing date of this application. The United States was an elected state in International Patent Application No. PCT/EP2007/006306.

### BACKGROUND

1. Technical Field

The present application relates to a rotary beverage bottle filling machine configured to fill beverage bottles with different diameters, sizes, and shapes without changing bottle carriers and a container treatment machine configured to handle containers with different diameters, sizes, and shapes without changing container carriers.

2. Background Information

Background information is for informational purposes only and does not necessarily admit that subsequently mentioned information and publications are prior art.

The present application relates to a handling machine for bottles or similar containers. The handling machine comprises at least one transporting element and a plurality of treatment stations provided at the transporting element for receiving one container each. The handling machine also has provided at each handling station at least two container mounts, each of which is matched to a container diameter and/or a container shape, and which can be moved during a container changeover of the handling machine between a ready position and a working position. The respective container mount interacts in a supporting and/or retaining manner with the respective container provided at the treatment station. The handling machine further comprises means for moving the container mounts of all or substantially all or most working stations during the container changeover.

Some handling machines for containers, for example for bottles, in a variety of forms, for example as rotary filling machines with a plurality of handling stations in the form of filling stations arranged around the circumference of a rotor, at which stations the containers are held suspended below a handling head configured as a filling element on a container carrier while being filled with a liquid product. For this purpose, said container carrier is fork-shaped or has a container mount or mount opening that opens toward the circumference of the rotor so that the respective container rests with a container flange or neck flange in the area of the container opening against the container carrier. To hold the containers suspended in this way, it is essential that the shape and/or size of the respective mount opening matches the shape and/or size, i.e. the outside diameter, for example, that the containers exhibit in the area of their container flanges.

With other container mounts provided on handling machines to interact in a retaining and/or supporting manner with the containers provided at the respective handling station, it is likewise necessary and/or desired that their shape and/or size match the shape and/or size of the containers to be processed in those regions of the containers' circumferential surface in interaction with the respective container mount.

When changing the handling machine over from one type of container to another (container change), which container type exhibits a different shape and/or size, i.e. a different diameter, in those areas that interact with the container mounts, a format change is also required and/or desired, i.e. the container mounts used previously must be or should be adapted to the containers used after the container change.

Some handling machines teach that the replacement of the container mounts of all or substantially all or most handling stations in the event of a format change, which is very labor-intensive and time-consuming, meaning for example long downtimes for the respective handling machine.

Some handling machines further teach a rotary filling machine having for each handling or filling station two mount openings of different sizes for the suspended retention of one container each arranged on an annular container carrier concentrically surrounding the vertical machine axis such that these containers rest with their container flange against the annular container carrier in the area of the respective mount opening. For a container change, the container mount openings associated with the handling or filling stations can, by means of a reciprocating or swivel motion of the annular container carrier around the vertical machine axis, be moved simultaneously or substantially simultaneously at all substantially all or most handling or filling stations between a ready position and a working position, in which the respective mount opening, and thus the container provided at this mount opening, is located in the required or desired filling position below the associated handling head or filling element. If the handling stations on the circumference of the rotor are arranged at very close intervals, which is imperative for high performance, the number of different mount openings associated with each handling station is limited, i.e. the handling machine can be changed over between two different container types or sizes.

### OBJECT OR OBJECTS

An object of the present application is to provide a handling machine that avoids, restricts, and/or minimizes this disadvantage. A handling machine for achieving this object is disclosed as a handling machine for bottles or similar containers, which comprises at least one transporting element, and further comprises a plurality of treatment stations provided at the transporting element for receiving one container each. Provided at each handling station are at least two container mounts, each of which is matched to a container diameter and/or a container shape, and which can be moved during a container changeover of the handling machine between a ready position and a working position. The respective container mount interacts in a supporting and/or retaining manner with the respective container provided at the treatment station. The handling machine of the present application further comprises means for moving the container mounts of all, substantially all, or most working stations during the container changeover. At least one of the container mounts of each handling station can also be replaced in addition to being moved between the ready position and the working position.

### SUMMARY

With a handling machine according to the present application, the mount openings matched to the shape and/or size, i.e. the form and/or diameter, of the containers are in container mounts or container carriers provided at each of the handling stations in such a manner as to enable for these container mounts and thus also for their mount openings the reciprocating motion between the ready position and the working position for the format change. Suitable means essentially ensure or promote that all, substantially all, or most handling stations perform this reciprocating motion together, e.g. by means of a common retaining and shifting element and/or possibly simultaneously or substantially simultaneously.

What also distinguishes the present application is the fact that the individual container mounts are not only designed for the reciprocating motion for the format change, but are also replaceably installed at the handling stations so that the respective handling machine can be optionally equipped with such container mounts matching the containers processed or primarily processed on a production line. This enables the respective handling machine to be adapted to the specific wishes of the user of such a machine, in one possible embodiment so that the user of the handling machine can switch quickly and easily between the container types used by the user.

Despite adaptation for a wide variety of container types, the design according to the present application also offers the possibility that the handling stations can be arranged at very tight intervals in the direction of transport of the transport element, e.g. a rotor, bearing these stations.

In at least one possible embodiment according to the present application, the handling device of the present application is used for handling blow molded PET bottles.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application discloses further embodiments of the present application. The present application in the form of a rotary handling machine configured as a filling machine is described in greater detail below with reference to the accompanying drawings, in which:

FIG. 1 shows in simplified form a top view of the handling machine configured as a filling machine together with a coupled sealing machine;

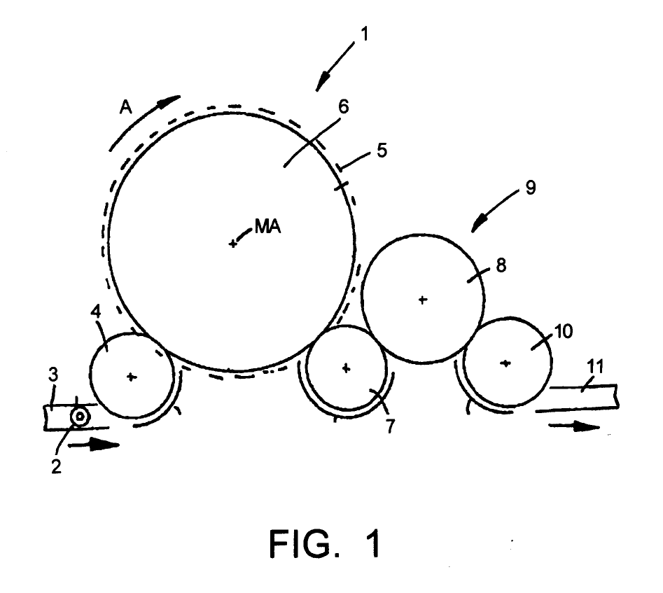

FIG. 2 shows a simplified and partial side view of two handling heads or filling elements provided on a rotating rotor of the handling machine;

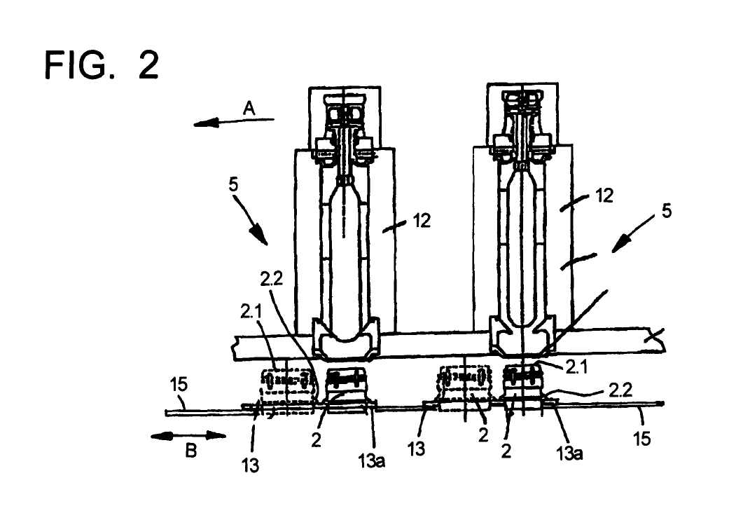

FIG. 3 shows a simplified partial view of an annular retaining and shifting element together with the replaceable container mounts or carriers located there;

FIG. 4 shows a simplified partial view of an annular retaining and shifting element together with one of each of three sets of replaceable container mounts or carriers located there; and

FIG. 5 shows schematically the main components of one possible embodiment example of a system for filling containers, for example a beverage bottling plant for filling bottles with at least one liquid beverage, in accordance with at least one possible embodiment according to the present application.

### DESCRIPTION OF EMBODIMENT OR EMBODIMENTS

In the figures, 1 is a rotary handling machine, and in one possible embodiment according to the present application a filling machine for filling containers 2 in the form of bottles with a liquid product.

The containers 2 are supplied to the handling machine 1 via a conveyor 3 and are fed individually via a container inlet in the form of a starwheel 4 to a handling station 5, which is arranged at close, regular intervals to a plurality of other handling stations 5 on the circumference of a rotor 6 driven in the direction of the arrow A around a vertical machine axis MA. The filled containers 2 are removed at a starwheel 7 forming the container outlet and each is transferred to one handling station on the rotor 8 of a sealing station 9.

The filled and sealed containers then pass via the an outlet starwheel 10 to a conveyor 11, by means of which the containers 2 fed to another application, such as a labeling machine.

Each handling station 5 comprises, among other things, a handling head 12 provided on the rotor 6, which is a filling element when the handling machine 1 is configured as a filling machine. Located below each handling head 12 during the handling of the containers 2 is a container mount in the form of a container carrier 13, at which the respective container 2 is held suspended from a container flange 2.2 in the area of its container mouth 2.1. To achieve this, each of the container carriers 13 rotating with the rotor 6 is provided with roughly semicircular mount openings or recesses 14, which relative to the machine axis MA are open on the radially outer side and whose cross-section or radius is the same as or slightly larger than the cross-section or radius of the containers 2 at the outer surface of the container neck, which (outer surface) is immediately or substantially adjacent to the that side of the container flange 2.2 facing away from the container mouth 2.1.

To handle containers 2 of different sizes, i.e. with different neck diameters, for example a neck diameter of twenty-eight millimeters or thirty-eight millimeters, with the handling machine 1, each handling station has associated with it not only the container carrier 13 with the recess 14 (for a neck diameter of twenty-eight millimeters, for example), but also another container carrier 13a with a recess 14a that matches the larger neck diameter (thirty-eight millimeters, for example) and is also open on the radially outer side relative to the machine axis MA.

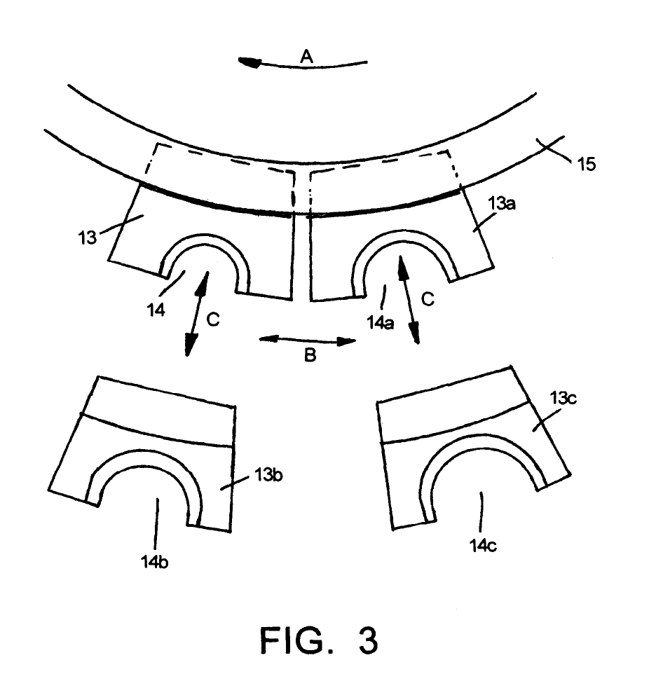

The two container carriers 13 and 13a or their recesses 14, 14a associated with each handling station 5 or the handling head 12 located there are offset from one another in the circumferential direction of the rotor 6. The container carriers 13 and 13a of each handling station 5 can also be moved so that the container carrier 13 can be positioned under each handling head 12 for the handling of containers 2 with the smaller neck diameter, and the container carrier 13a can be positioned under the handling head 12 for the handling of containers 2 with the larger neck diameter. In the embodiment shown here, this is accomplished by displacing the container carriers 13 and 13a in the circumferential direction of the rotor 6, as is suggested in FIG. 3 by the double-headed arrow B. Furthermore, the container carriers 13 and 13a are both replaceable, so that the container carriers 13 and 13a provided at the handling stations 5 can be replaced by other container carriers 13b, 13c that differ in terms of the size of the mounts or recesses 14b, 14c, in one possible embodiment using quick-release systems that enable rapid removal and attachment of the container carriers 13, 13a, 13b, 13c.

In the embodiment shown, the container carriers 13 and 13a of all or substantially all or most handling stations 5 are replaceably mounted to the handling machine 1 on a common, annular retaining or shifting element 15 that concentrically surrounds the vertical machine axis so that in the event of a container changeover of the handling machine 1, the container carriers 13 and 13a at every handling station 5 are switched by rotating or swiveling the retaining and shifting element 15 over an angle corresponding to the axial interval between the container carriers 13 and 13a or the mounts 14 and 14a provided at each handling station 5.

In at least one possible embodiment according to the present application, the annular ring or retaining and shifting element 15 comprises pockets in which the container carriers 13, 13a, 13b, and 13c are removably fastened. The pockets are found along the periphery of the annular ring or retaining and shifting element 15. The container carriers are fastened in predetermined intervals. For example, container carriers 13a are fastened in every other, or every second, pocket around the periphery of the annular ring or retaining and shifting element 15. The other size of container carriers installed in the annular ring or retaining and shifting element 15, for example 13c, are fastened in the remaining pockets, with one container carrier 13c in between the container carriers 13a. In other words, the size of container carrier alternates along the periphery of the annular ring or retaining and shifting element 15. It is possible to non-permanently fasten the container carriers 13, 13a, 13b, and 13c using quick-connect or quick-lock or quick-release systems or screws, among other things. Because the container carriers 13, 13a, 13b, and 13c can easily be removed from the annular ring or retaining and shifting element 15, a plurality of combinations can be created with the annular ring or retaining and shifting element 15. For example, container carriers 13a and 13c may be removably fastened to the annular ring or retaining and shifting element 15. When and/or if a bottle size changeover occurs and a third container carrier, for example container carrier 13, should be used in the handling machine 1, one of the sets of container carriers, either 13a or 13c, are removed or uninstalled from the pockets along the periphery of the annular ring or retaining and shifting element 15. Container carriers 13 are then installed in the empty gaps, and the bottling process can then be resumed.

As is suggested schematically in FIG. 3 by the double-headed arrow C, the replaceable container carriers 13 and 13a on the annular retaining and shifting element 15 are inserted radially from the outside and secured by locking. Each container carrier 13 or 13a can be removed from the retaining and shifting element by means of an outward radial motion after releasing the lock. It is also possible to non-permanently fix the container carriers 13 and 13a to the annular retaining and shifting element 15 using screws.

The container carriers 13 and 13a installed in the handling machine 1 can be replaced by container carriers 13b and 13c to reconfigure the handling machine 1 for the optional handling of containers with a neck diameter of thirty-three millimeters or forty-three millimeters.

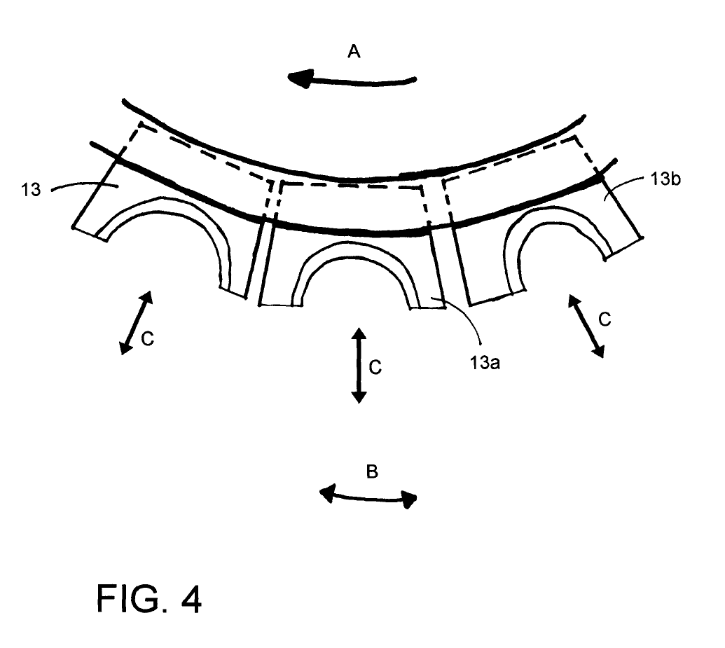

FIG. 4 shows a simplified annular ring or annular retaining and shifting element 15. In this embodiment of the present application, the annular ring or annular retaining and shifting element 15 is configured to have at least three sets of carriers 13, 13a, and 13b mounted on the annular ring or annular retaining and shifting element 15. In this embodiment, one container carrier is in the working position while the two other carriers are in the ready position. For example, when carrier 13 is in the working position, carriers 13a and 13b are in the ready position. When carrier 13a is in the working position, carriers 13 and 13b are in the ready position. When carrier 13b is in the working position, carriers 13 and 13a are in the ready position.

In the embodiment seen in FIG. 4, when container carrier 13 is in the working position, the carrier 13 can be displaced from the working position and moved into ready position by the rotation of the annular ring or annular retaining and shifting element 15. Once container carrier 13 is out of the working position, another container carrier, for example either 13a or 13b, moves into working position. Which container carrier moves into the working position depends on the direction of rotation, shown by the double-headed arrow B, and the degree of rotation of the annular ring or annular retaining and shifting element 15.

Similar to that of FIG. 3, the replaceable container carriers 13, 13a , and 13b, of the embodiment illustrated in FIG. 4, on the annular ring or annular retaining and shifting element 15 are inserted radially from the outside and secured by locking, illustrated by the double-headed arrow C. Each container carrier 13, 13a or 13b can be removed from the retaining and shifting element by means of an outward radial motion after releasing the lock. It is also possible to non-permanently fix the container carriers 13 and 13a to the annular retaining and shifting element 15 using screws and/or quick-release or quick-connect systems.

In at least one possible embodiment of the present application, the handling machine 1 can be reconfigured for the handling of containers 2 with very different neck diameters. The different container carriers 13 and 13a provided on the rotor 6 and which can be moved or displaced in the circumferential direction of the rotor to reconfigure the handling machine 1 enable the handling machine to quickly change over between two different container sizes, in one possible embodiment between such container sizes as are typically processed in a production facility featuring the handling machine 1.

Because the container carriers 13 and 13a are replaceable and in one possible embodiment designed as quick release parts that interact with quick release fasteners, the handling machine 1 can be reconfigured for a plurality of different container sizes and can be adapted to the principle container sizes used by the respective customer prior to delivery. It is also possible to produce a standard version of the handling machine 1 and then custom equip the machine with container carriers 13 through 13c that are precisely or substantially precisely or generally matched to the dimensions of the customer-specific containers.

It was assumed above that two different container carriers 13 through 13c are mounted at each handling station 5. The number of container carriers mounted at each handling station can also be greater than two, of course.

It was further assumed above that the container carriers 13, 13a of all or substantially all or most handling stations 5 can are replaceably arranged on a common, annular retaining and shifting element 5. Of course, it is also possible to have multiple mobile, semi-annular retaining and shifting elements, for example, on which e.g. the container carriers 13, 13a for one handling station or group of handling stations are arranged and are moved in the event of a container change by means of a common controller.

It was also assumed above that the container carriers 13 through 13c are moveably and replaceably arranged on the rotor 6. It is understood that corresponding container carriers that facilitate a container change can also be provided on other functional elements, such as on rotor 8 of the sealing machine 9 and/or possibly the starwheels 4, 7 and 10.

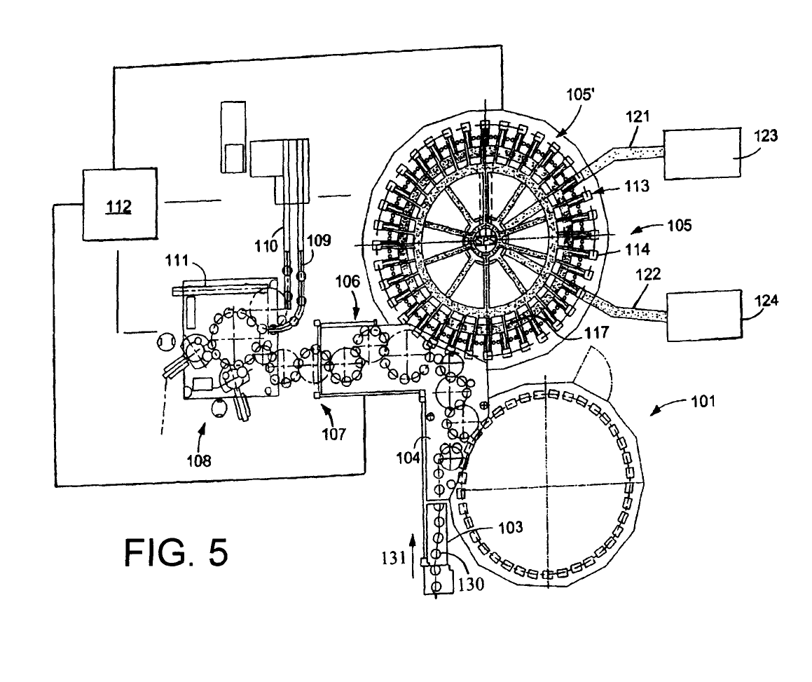

FIG. 5 shows schematically the main components of one possible embodiment example of a system for filling containers, for example, a beverage bottling plant for filling bottles 130 with at least one liquid beverage, in accordance with at least one possible embodiment, in which system or plant could possibly be utilized at least one aspect, or several aspects, of the embodiments disclosed herein.

FIG. 5 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 5, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

The present application was described above with reference to one possible embodiment. It will be understood that numerous modifications and derivations are possible without departing from the teaching on which the present application is based.

A handling machine for bottles or similar containers, having at least one transporting element, further having a plurality of handling stations provided at the transporting element for receiving one container each, further having at least two different receptacle mounts provided at each treatment station, wherein the mounts can be moved during a container changeover of the treatment machine between a ready position and a working position, in which the respective container mount interacts in a supporting and/or retaining manner with the respective container provided at the handling station, and further having means for moving the container mounts of all or substantially all or most working stations during the container changeover.

One feature or aspect of an embodiment is believed at the time if the filing of this patent application to possibly reside broadly in a handling machine for bottles or similar containers 2, having at least one transporting element 6, further having a plurality of treatment stations 5 provided at the transporting element 6 for receiving one container each, further having provided at each handling station 5 at least two container mounts 13, 13a, 13b, 13c, each of which is matched to a container diameter and/or a container shape, and which can be moved during a container changeover of the handling machine 1 between a ready position and a working position, in which the respective container mount 13 through 13c interacts in a supporting and/or retaining manner with the respective container 2 provided at the treatment station 5, and further having means 15 for moving the container mounts 13 through 13c of all or substantially all or most working stations 5 during the container changeover, wherein at least one container mount 13 through 13c of each handling station 5 can also be replaced in addition to being moved between the ready position and the working position.

Another feature or aspect of an embodiment is believed at the time if the filing of this patent application to possibly reside broadly in the handling machine, wherein the transporting element 6 is a powered transporting element rotating around a vertical machine axis, such as a rotor 6, 8.

Yet another feature or aspect of an embodiment is believed at the time if the filing of this patent application to possibly reside broadly in the handling machine, wherein the container mounts 13 through 13c are configured for suspending the containers 2 from container flange 2.2 in the area of a container opening 2.1.

Still another feature or aspect of an embodiment is believed at the time if the filing of this patent application to possibly reside broadly in the handling machine, wherein the container mounts 13 through 13c each form a mount opening 14 through 14c that matches the outside diameter of the containers 2 in the area of the container flange 2.2.

A further feature or aspect of an embodiment is believed at the time if the filing of this patent application to possibly reside broadly in the handling machine, wherein at least two of the container mounts 13 through 13c associated with each handling station 5 are replaceably provided on a retaining and shifting element 15, which for the reciprocating motion is mounted on the transporting element 6 so as to move in the direction of transport A and opposite the direction of transport A of the transporting element 6, for example.

Another feature or aspect of an embodiment is believed at the time if the filing of this patent application to possibly reside broadly in the handling machine, wherein the container mounts 13 through 13c of multiple adjacent handling stations 5 are provided on a common retaining and shifting element 15, and that at least one container mount 13 through 13c of each handling station 5 is non-permanently fastened to the retaining and shifting element 15.

Yet another feature or aspect of an embodiment is believed at the time if the filing of this patent application to possibly reside broadly in the handling machine, wherein the container mounts 13 through 13c of all or substantially all or most handling stations 5 are provided on a common retaining and shifting element 15, for example on an annular retaining and shifting element concentrically surrounding a vertical machine axis MA, can be moved together with this for the reciprocating motion.

Still another feature or aspect of an embodiment is believed at the time if the filing of this patent application to possibly reside broadly in the handling machine, wherein the at least one replaceable container mount 13 through 13c of each handling station 5 is designed as a quick release part and/or is secured there in a quick release seat.

A further feature or aspect of an embodiment is believed at the time if the filing of this patent application to possibly reside broadly in the handling machine, wherein a handling head 12 is provided at each handling station 5 and that each container mount 13 through 13c in the working position is arranged below the handling head 12.

Another feature or aspect of an embodiment is believed at the time if the filing of this patent application to possibly reside broadly in the handling machine, wherein the container mount 13 through 13c in the ready position is arranged below but laterally offset from the handling head 12.

Yet another feature or aspect of an embodiment is believed at the time if the filing of this patent application to possibly reside broadly in the handling machine, wherein it is configured as a filling machine or a sealing machine or a machine for sterilizing the containers 2.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

Some examples of stepping motors that may possibly be utilized or possibly adapted for use in at least one possible embodiment of the present application may possibly be found in the following U.S. patents: U.S. Pat. No. 6,348,774 issued to Andersen et al. on Feb. 19, 2002; U.S. Pat. No. 6,373,209 issued to Gerber et al. on Apr. 16, 2002; U.S. Pat. No. 6,424,061 issued to Fukuda et al. on Jul. 23, 2002; U.S. Pat. No. 6,509,663 issued to Aoun on Jan. 15, 2003; U.S. Pat. No. 6,548,923 to Ohnishi et al. on Apr. 15, 2003; and U.S. Pat. No. 6,661,193 issued to Tsai on Dec. 9, 2003.

Some examples of servo-motors that may possibly be utilized or possibly adapted for use in at least one possible embodiment of the present application may possibly be found in the following U.S. patents: U.S. Pat. No. 4,050,434 issued to Zbikowski et al. on Sep. 27, 1977; U.S. Pat. No. 4,365,538 issued to Andoh on Dec. 28, 1982; U.S. Pat. No. 4,550,626 issued to Brouter on Nov. 5, 1985; U.S. Pat. No. 4,760,699 issued to Jacobsen et al. on Aug. 2, 1988; U.S. Pat. No. 5,076,568 issued to de Jong et al. on Dec. 31, 1991; and U.S. Pat. No. 6,025,684 issued to Yasui on Feb. 15, 2000.

Some examples of synchronous motors which may possibly be utilized or adapted for use in at least one possible embodiment may possibly be found in the following U.S. Patents: U.S. Pat. No. 6,713,899, entitled “Linear synchronous motor;” U.S. Pat. No. 6,486,581, entitled “Interior permanent magnet synchronous motor;” U.S. Pat. No. 6,424,114, entitled “Synchronous motor;” U.S. Pat. No. 6,388,353, entitled “Elongated permanent magnet synchronous motor;” U.S. Pat. No. 6,329,728, entitled “Cylinder-type linear synchronous motor;” U.S. Pat. No. 6,025,659, entitled “Synchronous motor with movable part having permanent magnets;” U.S. Pat. No. 5,936,322, entitled “Permanent magnet type synchronous motor;” and U.S. Pat. No. 5,448,123, entitled “Electric synchronous motor.”

Some examples of quick change systems which may possibly be adapted for use or utilized in the present application may possibly be found in the following U.S. patents: U.S. Pat. No. 5,778,633, having the title “QUICK CHANGE LEDGE SUPPORT ASSEMBLY FOR FILLING AND CAPPING MACHINES,” published on Jul. 14, 1998; U.S. Pat. No. 5,711,411, having the title “QUICK CHANGEOVER FILLING, CENTERING BRACKET,” published on Jan. 27, 1998; U.S. Pat. No. 5,671,585, having the title “QUICK CHANGE CONNECTION FOR FILLING AND CAPPING MACHINES,” published on Sep. 30, 1997; and U.S. Pat. No. 4,635,662, having the title “INLINE BOTTLE RINSER WITH QUICK BOTTLE SIZED CHANGEOVER CAPABILITY,” published on Jan. 13, 1987.

The following patents, patent applications or patent publications, are hereby incorporated by reference as if set forth in their entirety herein: WO 03/070579A1, having the title “PLASTIC WATER BOTTLE AND APPARATUS AND METHOD TO PREVENT BOTTLE ROTATION,” published on Aug. 28, 2003.

All of the patents, patent applications or patent publications, which were cited in the International Search Report dated Nov. 16, 2007, and/or cited elsewhere are hereby incorporated by reference as if set forth in their entirety herein as follows: WO 2006/077050, having the English equivalent of the German title “METHOD AND DEVICE FOR HOLDING VESSELS,” published on Jul. 27, 2006; EP 1,512,663, having the following German title “VORRICHTUNG ZUM WECHSELN VON AN UMLAUFENDEN BEHÄLTERBEHANDLUNGSMASCHINEN ANGEORDNETEN BAUTEILEN,” published on Mar. 9, 2005; and U.S. Pat. No. 5,778,633, having the title “QUICK CHANGE LEDGE SUPPORT ASSEMBLY FOR FILLING AND CAPPING MACHINES,” published on Jul. 14, 1998.

All of the patents, patent applications or patent publications, which were cited in the German Office Action, dated Jun. 12, 2007, and/or cited elsewhere are hereby incorporated by reference as if set forth in their entirety herein as follows: DE 10 2005 002 715, having the following English translation of the German title “METHOD AND DEVICE FOR HOLDING VESSELS,” published on Aug. 3, 2006; DE 701 799, having the following German title “VORRICHTUNG ZUR VERAENDERUNG DER FUELLHOEHO,” published on Jan. 23, 1941; and DE 103 40 365, having the following German title “VORRICHTUNG ZUM WECHSELN VON AN UMLAUFENDEN BEHÄLTERBEHANDLUNGSMASCHINEN ANGEORDNETEN BAUTEILEN,” published on Mar. 24, 2005.

U.S. patent application Ser. No. 10/931,817, filed on Sep. 1, 2004, having inventor Dieter-Rudolf KRULITSCH, Attorney Docket No. NHL-HOL-82, and title A BEVERAGE BOTTLING PLANT FOR FILLING BOTTLES WITH A LIQUID BEVERAGE FILLING MATERIAL, HAVING AN APPARATUS FOR EXCHANGING OPERATING UNITS DISPOSED AT ROTATING CONTAINER HANDLING MACHINES, and its corresponding Federal Republic of Germany Patent Application No. DE 103 40 8365.5, filed on Sep. 2, 2003 and inventor Dieter-Rudolf KRULITSCH are hereby incorporated by reference as if set forth in their entirety herein.

The patents, patent applications, and patent publication listed above, beginning on line 622 on page 30 in the paragraph with the phrase: “Some examples of stepping motors . . . ” and ending on line 700 on page 34 in the paragraph with the phrase: “ . . . and inventor Dieter-Rudolf KRULITSCH are hereby incorporated by reference as if set forth in their entirety herein” are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 033 511.2, filed on Jul. 20, 2006, having inventor Volker TILL, and DE-OS 10 2006 033 511.2 and DE-PS 10 2006 033 511.2, and International Application No. PCT/EP2007/006306, filed on Jul. 17, 2007, having WIPO Publication No. WO 2008/009408 and inventor Volker TILL, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/006306 and German Patent Application 10 2006 033 511.2 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/006306 and DE 10 2006 033 511.2 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Handling machine
2 Container
2.1 Container mouth
2.2 Container flange
3 Conveyor
4 Starwheel
5 Handling station
6 Rotor
7 Starwheel
8 Rotor
9 Sealing machine
10 Starwheel
11 Conveyor
12 Handling head or filling element
13-13c Container carrier
14-14c Mount opening for the neck of the container
15 Retaining and shifting element
A Direction of rotation of the rotor 6
B Shifting motion of the container carriers on the handling machine or the rotor
C Direction of insertion and removal of the container carriers

What is claimed is:

1. A method of customizing a rotary beverage bottle filling machine for a customer according to said customer's specifications, shipping customized parts for said rotary beverage bottle filling machine to said customer, and assembling at a customer's location said rotary beverage bottle filling machine in said customized form, said method comprising the steps of:
producing a rotary beverage bottle filling machine frame, a rotary beverage bottle filling machine reservoir, a plurality of rotary beverage bottle filling machine filling elements, a plurality of rotary beverage bottle filling machine connections between said rotary beverage bottle filling machine reservoir and each of said plurality of rotary beverage bottle filling machine filling elements; a standard annular ring being configured to be adjustable for use in numerous beverage bottle filling machines which beverage bottle filling machines configured to fill numerous beverage bottles having different beverage bottle diameters, beverage bottle sizes, and/or beverage bottle shapes and which annular ring is configured to be mounted on said rotary beverage bottle filling machine; and an arrangement being configured to rotate said standard annular ring and to orient a beverage bottle held by said standard annular ring below each of said plurality of rotary beverage bottle filling machine filling elements;
said standard annular ring comprising standardized, identical, open pockets being configured to accept bottle carriers, which standardized, identical, open pockets are disposed on the periphery of said standard annular ring;
customizing said rotary beverage bottle filling machine to said customer's specifications and factory-installing, using factory methods, a first set of bottle carriers in said standardized, identical, open pockets at predetermined intervals from one another around the periphery of said standard annular ring prior to shipping;
further customizing said rotary beverage bottle filling machine to said customer's specifications and factory-installing, using factory methods, a second set of bottle carriers in said standardized, identical, open pockets at predetermined intervals from one another around the periphery of said standard annular ring and disposing at a predetermined distance each of said second set of bottle carriers adjacent to a corresponding one of said first set of bottle carriers prior to shipping;
said first set of bottle carriers and said second set of bottle carriers both comprising identical outside dimensions in order to be non-permanently fastened in said standardized, identical, open pockets;
said first set of bottle carriers comprising a first set of inner dimensions configured to accept beverage bottles of a first diameter, size, or shape;
said second set of bottle carriers comprising a second set of inner dimensions configured to accept beverage bottles of a second diameter, size, or shape;
said first set of inner dimensions of said first set of bottle carriers being different from said second set of inner dimensions of said second set of bottle carriers;
shipping said parts for said rotary beverage bottle filling machine, including said rotary beverage bottle filling machine frame, said rotary bottle filling machine reservoir, said plurality of rotary beverage bottle filling machine filling elements, said plurality of rotary beverage bottle filling machine connections between said rotary beverage bottle filling machine reservoir and each of said plurality of rotary beverage bottle filling machine filling elements, and said arrangement, with said customized annular ring with both said first set of bottle carriers and said second set of bottle carriers installed to said customer's location;
assembling said rotary beverage bottle filling machine frame, said rotary beverage bottle filling machine reservoir, said plurality of rotary beverage bottle filling machine filling elements, said plurality of rotary beverage bottle filling machine connections between said rotary beverage bottle filling machine reservoir and each of said plurality of rotary beverage bottle filling machine filling elements, said arrangement, and said standard annular ring and forming said customized rotary beverage bottle filling machine;
said arrangement being configured to rotate said customized annular ring in order to move each of said first set of bottle carriers under each of said plurality of rotary beverage bottle filling machine filling elements to thus permit filling of beverage bottles held by each of said first set of bottle carriers; and
said arrangement being further configured to rotate said customized annular ring in order to move each of said second set of bottle carriers under each of said plurality of rotary beverage bottle filling machine filling elements to thus permit filling of beverage bottles held by each of said second set of bottle carriers.

2. The method of customizing a rotary beverage bottle filling machine according to claim 1, wherein:
said rotary beverage bottle filling machine further comprises:
a vertical axis; and
a rotary structure configured to hold said customized ring, and thus said at least two sets of bottle carriers, and to transport bottles; and
said rotary structure is configured to rotate about said vertical axis in a direction of rotation.

3. The method of customizing a rotary beverage bottle filling machine according to claim 2, wherein said at least two sets of bottle carriers are further configured to suspend beverage bottles, having beverage bottle flanges, by the beverage bottle flanges;
each of said at least two sets of bottle carriers further comprises a carrier opening configured to accept beverage bottles and suspend beverage bottles by beverage bottle flanges; and
said carrier opening of each of said at least two sets of bottle carriers comprises a diameter which matches the diameter of a beverage bottle below the beverage botle flange.

4. The method of customizing a rotary beverage bottle filling machine according to claim 3, wherein said customized annular ring is configured to rotate both with the direction of rotation of said transporting arrangement and against the direction of rotation of said transporting arrangement.

5. The method of customizing a rotary beverage bottle filling machine according to claim 4, wherein said at least two sets of bottle carriers are removably fastened to said standard annular ring;
quick-release systems are configured to fasten at least a portion of said at least two sets of bottle carriers;
each of said at least two sets of bottle carriers are configured to be rotated into either a working position or a ready position;
each of said at least two sets of bottle carriers is configured to be positioned under a corresponding one of said rotary beverage bottle filling machine filling elements upon being in said working position;
each of said at least two sets of bottle carriers is configured to be positioned below, but laterally offset from, a corresponding one of said rotary beverage bottle filling machine filling elements upon being in said ready position.

6. A rotary beverage bottle filling machine made according to the process of claim 1.

7. A method of customizing a rotary beverage bottle filling machine for a customer according to said customer's specifications, shipping customized parts for said rotary beverage bottle filling machine to said customer, and assembling at a customer's location said rotary beverage bottle filling machine in said customized form, said method comprising the steps of:
producing a rotary beverage bottle filling machine frame, a rotary beverage bottle filling machine reservoir, a plurality of rotary beverage bottle filling machine filling elements, a plurality of rotary beverage bottle filling machine connections between said rotary beverage bottle filling machine reservoir and each of said plurality of rotary beverage bottle filling machine filling elements; a standard annular ring being configured to be adjustable for use in numerous beverage bottle filling machines which beverage bottle filling machines are configured to fill numerous beverage bottles having different beverage bottle diameters, beverage bottle sizes, and/or beverage bottle shapes and which annular ring is configured to be mounted on said rotary beverage bottle filling machine; and an arrangement being configured to rotate said standard annular ring and to orient a beverage bottle held by said standard annular ring below each of said plurality of rotary beverage bottle filling machine filling elements;
said standard annular ring comprising standardized, identical, open pockets being configured to accept bottle carriers, which standardized, identical, open pockets are disposed on the periphery of said standard annular ring;
customizing said rotary beverage bottle filling machine to said customer's specifications and non-permanently fastening a first set of bottle carriers in said standardized, identical, open pockets at predetermined intervals from one another around the periphery of said standard annular ring prior to shipping;
further customizing said rotary beverage bottle filling machine to said customer's specifications and non-permanently fastening a second set of bottle carriers in said standardized, identical, open pockets at predetermined intervals from one another around the periphery of said standard annular ring and disposing at a predetermined distance each of said second set of bottle carriers adjacent to a corresponding one of said first set of bottle carriers prior to shipping;
said first set of bottle carriers and said second set of bottle carriers both comprising identical outside dimensions in order to be non-permanently fastened in said standardized, identical, open pockets;
said first set of bottle carriers comprising a first set of inner dimensions configured to accept beverage bottles of a first diameter, size, or shape;
said second set of bottle carriers comprising a second set of inner dimensions configured to accept beverage bottles of a second diameter, size, shape;
said first set of inner dimensions of said first set of bottle carriers being different from said second set of inner dimensions of said second set of bottle carriers;
shipping said parts for said rotary beverage bottle filling machine, including said rotary beverage bottle filling machine frame, said rotary bottle filling machine reservoir, said plurality of rotary beverage bottle filling machine filling elements, said plurality of rotary beverage bottle filling machine connections between said rotary beverage bottle filling machine reservoir and each of said plurality of rotary beverage bottle filling machine filling elements, and said arrangement, with said customized annular ring with both said first set of bottle carriers and said second set of bottle carriers installed to said customer's location;
assembling said rotary beverage bottle filling machine frame, said rotary beverage bottle filling machine reservoir, said plurality of rotary beverage bottle filling machine filling elements, said plurality of rotary beverage bottle filling machine connections between said rotary beverage bottle filling machine reservoir and each of said plurality of rotary beverage bottle filling machine filling elements, said arrangement, and said standard annular ring and forming said customized rotary beverage bottle filling machine;
said arrangement being configured to rotate said customized annular ring in order to move each of said first set of bottle carriers under each of said plurality of rotary beverage bottle filling machine filling elements to thus permit filling of beverage bottles held by each of said first set of bottle carriers; and
said arrangement being further configured to rotate said customized annular ring in order to move each of said second set of bottle carriers under each of said plurality of rotary beverage bottle filling machine filling elements to thus permit filling of beverage bottles held by each of said second set of bottle carriers.

8. The method of customizing a rotary beverage bottle filling machine according to claim 7, wherein:
said rotary beverage bottle filling machine further comprises:
a vertical axis; and
a rotary structure configured to hold said customized ring, and thus said at least two sets of bottle carriers, and to transport bottles; and
said rotary structure is configured to rotate about said vertical axis in a direction of rotation.

9. The method of customizing a rotary beverage bottle filling machine according to claim 8, wherein said at least two sets of bottle carriers are further configured to suspend beverage bottles, having beverage bottle flanges, by the beverage bottle flanges;
each of said at least two sets of bottle carriers further comprises a carrier opening configured to accept beverage bottles and suspend beverage bottles by beverage bottle flanges; and
said carrier opening of each of said at least two sets of bottle carriers comprises a diameter which matches the diameter of a beverage bottle below the beverage botle flange.

10. The method of customizing a rotary beverage bottle filling machine according to claim 9, wherein said customized annular ring is configured to rotate both with the direction of rotation of said transporting arrangement and against the direction of rotation of said transporting arrangement.

11. The method of customizing a rotary beverage bottle filling machine according to claim 10, wherein said at least two sets of bottle carriers are removably fastened to said standard annular ring;
quick-release systems are configured to fasten at least a portion of said at least two sets of bottle carriers;
each of said at least two sets of bottle carriers are configured to be rotated into either a working position or a ready position;
each of said at least two sets of bottle carriers is configured to be positioned under a corresponding one of said rotary beverage bottle filling machine filling elements upon being in said working position;
each of said at least two sets of bottle carriers is configured to be positioned below, but laterally offset from, a corresponding one of said rotary beverage bottle filling machine filling elements upon being in said ready position.

12. A rotary beverage bottle filling machine made according to the process of claim 11.

13. A method of customizing a rotary container treatment machine, such as a container filling machine, a container closing machine, or a container sterilizing arrangement, for a customer according to said customer's specifications, shipping parts for said rotary container treatment machine to said customer, and assembling at said customer's location said rotary container treatment machine in customized form, said method comprising the steps of:
producing a rotary container treatment machine frame, a rotary container treatment machine reservoir, a plurality of rotary container treatment machine treatment elements, a plurality of rotary container treatment machine connections between said rotary container treatment machine reservoir and each of said plurality of rotary container treatment machine treatment elements; a standard annular ring being configured to be adjustable for use in numerous container treatment machines which container treatment machines can treat numerous containers with different container diameters, container sizes, and/or container shapes and which annular ring is configured to be disposed on said rotary container treatment machine; and an arrangement being configured to rotate said standard annular ring of said rotary container treatment machine and to orient a container below each of said plurality of rotary container treatment machine treatment elements;
said standard annular ring comprising standardized, identical, open pockets being configured to accept container carriers, which standardized, identical, open pockets are disposed on the periphery of said standard annular ring;
producing at least two sets of container carriers being configured to be fastened in said standardized, identical, open pockets;
said at least two sets of container carriers comprising identical outside dimensions in order to be fastened in said standardized, identical, open pockets;
said at least two sets of container carriers comprising:
a first set of container carriers configured to accept containers of a first size; and
a second set of container carriers configured to accept containers of a second size;
said first set of container carriers and said second set of container carriers both comprising identical outside dimensions in order to be fastened in said standardized, identical, open pockets;
said first set of container carriers comprising a first set of inner dimensions which inner dimensions are configured to accept containers of a first diameter, size, or shape;
said second set of container carriers comprising a second set of inner dimensions which inner dimensions are configured to accept containers of a second diameter, size, or shape;
said first set of inner dimensions of said first set of container carriers being different from said second set of inner dimensions of said second set of container carriers;
shipping said parts for said rotary container treatment machine, including said rotary container treatment machine frame, said rotary container treatment machine reservoir, said plurality of rotary container treatment machine treatment elements, said plurality of rotary container treatment machine connections between said rotary container treatment machine reservoir and each of said plurality of rotary container treatment machine container elements, said arrangement, said standard annular ring, and said at least two sets of container carriers, to said customer's location; and
assembling said rotary container treatment machine frame, said rotary container treatment machine reservoir, said plurality of rotary container treatment machine treatment elements, said plurality of rotary container treatment machine connections between said rotary container treatment machine reservoir and each of said plurality of rotary container treatment machine treatment elements, said arrangement, and said standard annular ring and forming said rotary container treatment machine;
customizing said rotary container treatment machine to said customer's specifications and fastening said first set of container carriers in said standardized, identical, open pockets at predetermined intervals from one another around the periphery of said standard annular ring;
further customizing said rotary container treatment machine to said customer's specifications and fastening said second set of container carriers in said standardized, identical, open pockets at predetermined intervals from one another around the periphery of said standard annular ring and disposing at a predetermined distance each of said second set of container carriers adjacent to a corresponding one of said first set of container carriers.

14. The method of customizing a rotary container treatment machine according to claim 13, wherein:
said rotary container treatment machine further comprises:
a vertical axis; and
a rotary structure configured to hold said customized ring, and thus said at least two sets of container carriers, and to transport containers; and
said rotary structure is configured to rotate about said vertical axis in a direction of rotation.

15. The method of customizing a rotary container treatment machine according to claim 14, wherein said at least two sets of container carriers are further configured to suspend containers, having container flanges, by the container flanges;
each of said at least two sets of container carriers further comprises a carrier opening configured to accept containers and suspend containers by container flanges; and
said carrier opening of each of said at least two sets of container carriers comprises a diameter which matches the diameter of a container below the container flange.

16. The method of customizing a rotary container treatment machine according to claim 15, wherein said customized annular ring is configured to rotate both with the direction of rotation of said transporting arrangement and against the direction of rotation of said transporting arrangement.

17. The method of customizing a rotary container treatment machine according to claim 16, wherein said at least two sets of container carriers are removably fastened to said standard annular ring; and
quick-release systems are configured to fasten at least a portion of said at least two sets of container carriers.

18. The method of customizing a rotary container treatment machine according to claim 17, wherein:
each of said at least two sets of container carriers are configured to be rotated into either a working position or a ready position;
each of said at least two sets of container carriers is configured to be positioned under a corresponding one of said rotary container treatment machine treatment elements upon being in said working position;
each of said at least two sets of container carriers is configured to be positioned below, but laterally offset from, a corresponding one of said rotary container treatment machine treatment elements upon being in said ready position; and
said rotary container treatment machine is further configured as either a rotary filling machine configured to fill containers, a rotary closing machine configured to close containers, or a rotary machine configured to sterilize containers.

19. A rotary container treatment machine made according to the process of claim 13.

20. A rotary container treatment machine made according to the process of claim 18.
